(19) United States
(12) Patent Application Publication
(10) Pub. No.: US 2026/0364559 A1
(43) Pub. Date: Nov. 19, 2026

(54) CHEMICAL PROCESSING VESSELS HAVING FLUID DIRECTORS AND METHODS OF OPERATING THE SAME

(71) Applicant: Dow Global Technologies LLC, Midland, MI (US)

(72) Inventors: Chi-Wei Tsang, Lake Jackson, TX (US); Quan Yuan, Sugarland, TX (US); Matthew T. Pretz, Lake Jackson, TX (US); Albert Meza, Cypress, TX (US); Richard E. Walter, Long Valley, NJ (US); Donald F. Shaw, Forked River, NJ (US); Fermin Alejandro Sandoval, Pearland, TX (US); Liwei Li, Houston, TX (US)

(73) Assignee: Dow Global Technologies LLC, Midland, MI (US)

(21) Appl. No.: 19/124,119

(22) PCT Filed: Oct. 27, 2023
(86) PCT No.: PCT/US2023/078021

§ 371 Date: Apr. 24, 2025

Related U.S. Application Data
(60) Provisional application No. 63/420,177, filed on Oct. 28, 2022.

(51) Int. Cl. B01J 8/20; B01J 8/00; B01J 8/18

(52) U.S. Cl. CPC B01J 8/20; B01J 8/0085; B01J 8/1872; B01J 2208/00017; B01J 2208/00743; B01J 2208/00884; B01J 2208/00911; B01J 2208/00929; B01J 2208/00938

(57) ABSTRACT

A chemical processing vessel may include a base, a grid distributor, a solids transport passage, an outer skirt, a fluid inlet, and a fluid director. The solids transport passage may extend between the base and the grid distributor at a central region of the base and grid distributor, respectively. The outer skirt may include a wall disposed radially around a periphery of the base and the grid distributor. The base, the grid distributor, the solids transport passage, and the outer skirt define an annular region between the outer skirt and the solids transport passage. The fluid inlet extends through the base. The fluid director is disposed within the annular region and is shaped to direct a fluid from the fluid inlet into the annular region in a fluid direction that is substantially tangential to the outer skirt. Also disclosed herein are methods of operating a chemical processing vessel.

### CROSS-REFERENCE TO RELATED APPLICATIONS

This application claims the benefit of U.S. Provisional Application Ser. No. 63/420,177 filed Oct. 28, 2022, the entire disclosure of which is hereby incorporated herein by reference.

### BACKGROUND

### Field

The present specification generally relates to chemical processing and, more specifically, to systems and methods for directing fluids through distributors.

### Technical Background

Gaseous chemicals may be fed into reactors or other vessels through distributors. Distributors may be utilized to promote balanced distribution of a fluid into such reactors or vessels. Such distribution of fluid may promote desired reactions and may maintain mass transport equilibriums in chemical systems.

### SUMMARY

In a number of chemical processes, fluids are fed into chemical processing vessels through grid distributors. In some chemical processes, solids, such as catalysts, may be simultaneously removed through a solids transport passage in a grid distributor while fluids are fed into the chemical processing vessels. Such grid distributors may have a central solids passage forming an annular region below the grid. In many conventional chemical processing vessels, the fluids fed into annular regions below the grid of the chemical processing vessels may create uneven temperatures in the surrounding solid components. Accordingly, a need exists for fluid directors that direct the fluid around the chemical processing vessel annular region such that more even temperatures are experienced by the chemical processing vessel. Embodiments of such fluid directors are described herein, where fluid directors direct the fluid substantially tangentially to the outer skirt of the chemical processing vessel.

According to one or more embodiments, a chemical processing vessel may comprise a base, a grid distributor, a solids transport passage, an outer skirt, a fluid inlet, and a fluid director. The solids transport passage may extend between the base and the grid distributor at a central region of the base and the grid distributor, respectively. The outer skirt may comprise a wall disposed radially around a periphery of the base and the grid distributor. The base, the grid distributor, the solids transport passage, and the outer skirt may define an annular region between the outer skirt and the solids transport passage. The fluid inlet may extend through the base and into the annular region. The fluid director may be disposed within the annular region and shaped to direct a fluid from the fluid inlet into the annular region in a fluid direction that is substantially tangential to the outer skirt.

According to one or more additional embodiments, a chemical processing vessel may be operated by a method comprising passing a fluid into the chemical processing vessel, and directing the fluid with a fluid director. The chemical processing vessel may comprise a base, a grid distributor, a solids transport passage, an outer skirt, a fluid inlet, and a fluid director. The solids transport passage may extend between the base and the grid distributor at a central region of the base and the grid distributor, respectively. The outer skirt may comprise a substantially frustum-shaped wall disposed radially around a periphery of the base and the grid distributor. The base, the grid distributor, the solids transport passage, and the outer skirt may define an annular region between the outer skirt and the solids transport passage. The fluid inlet may extend through the base and into the annular region. The fluid director may be disposed within the annular region and shaped to direct a fluid from the fluid inlet into the annular region in a fluid direction that is substantially tangential to the outer skirt. The fluid may be directed from the fluid inlet into the annular region in a fluid direction that is substantially tangential to the outer skirt.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

FIG. 1 is a schematic illustration of a cross-sectional side view of a fluid director within a chemical processing vessel, in accordance with one or more embodiments of the present disclosure;

FIG. 2 is a schematic illustration of a perspective view of a grid distributor and a solids transport passage of the chemical processing vessel of FIG. 1, in accordance with one or more embodiments of the present disclosure;

FIG. 3 is a schematic illustration of a reactor system, in accordance with one or more embodiments of the present disclosure;

FIG. 4 is a schematic illustration of a top view of the fluid director of FIG. 1, in accordance with one or more embodiments of the present disclosure; and

FIG. 5 is a schematic illustration of a cross-sectional side view of another fluid director within a chemical processing vessel, according to one or more embodiments of the present disclosure;

FIG. 6 is a schematic illustration of a cross-sectional side view of another fluid director within a chemical processing vessel, according to one or more embodiments of the present disclosure;

FIG. 7A is a schematic illustration of a model of the temperatures of a solids transport passage of a chemical processing vessel with a flat fluid director, in accordance with one or more embodiments of the present disclosure;

FIG. 7B is a schematic illustration of a model of the temperatures of a solids transport passage of a chemical processing vessel with a curved fluid director, in accordance with one or more embodiments of the present disclosure;

FIG. 8A is a schematic illustration of a model of the temperatures of a grid distributor of a chemical processing vessel with a flat fluid director, in accordance with one or more embodiments of the present disclosure; and

FIG. 8B is a schematic illustration of a model of the temperatures of a grid distributor of a chemical processing vessel with a curved fluid director, in accordance with one or more embodiments of the present disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

The present disclosure is directed, according to one or more embodiments described herein, towards chemical processing vessels having fluid directors and methods of operating such chemical processing vessels. Generally, the chemical processing vessels described herein may comprise a solids transport passage substantially centered within the chemical processing vessel and an outer skirt surrounding the solids transport passage. Accordingly, the outer skirt may define an annular region between the outer skirt and the solids transport passage. The chemical processing vessels generally include a fluid inlet and a fluid director above the fluid inlet and disposed within the annular region. The fluid directors may be shaped to direct a fluid from the fluid inlet into the annular region in a fluid direction that is substantially tangential to the walls of the outer skirt.

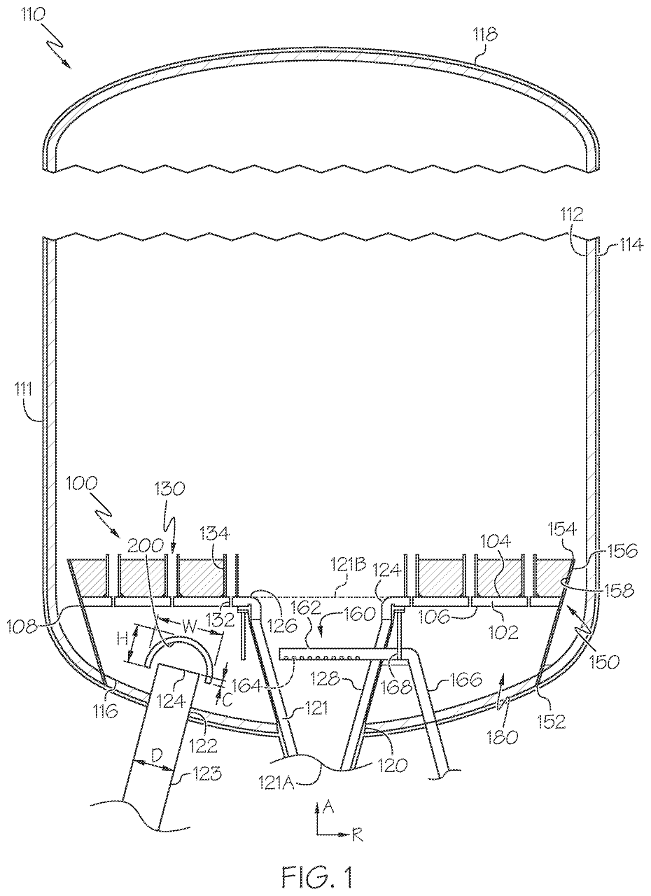

Referring now to FIG. 1, an embodiment of a chemical processing vessel 110 is schematically depicted. The chemical processing vessel 110 may have various configurations. The chemical processing vessel 110 may have a cylindrical shape. For example, the chemical processing vessel 110 may include a rounded hollow shape with a longitudinal axis A. The longitudinal axis A may define a radial direction R extending therefrom. The chemical processing vessel 110 may include side walls 111, a base 116, a top 118, a catalyst outlet 120, and a receiving passageway 122. The side walls 111, the base 116, and the top 118 of the chemical processing vessel 110 may include a refractory-lined inner wall 112 and an outer wall 114.

According to one or more embodiments, the chemical processing vessel 110 may include a grid distributor 100 for distributing a fluid in the chemical processing vessel 110. The grid distributor 100 may comprise a plate 102. The plate 102 may comprise an upper surface 104 and a bottom surface 106. The bottom surface 106 may be opposite the upper surface 104 and spaced apart from the upper surface 104. The distance between the upper surface 104 and the bottom surface 106 may define a thickness of the plate 102. The plate 102 may comprise an outer surface 108, stretching around the periphery of the plate 102. The outer surface 108 may have a portion that is normal to the upper surface 104 and the bottom surface 106. The plate 102 may have an average diameter from greater than or equal to 5 feet (1.5 meters (m)) to less than or equal to 75 feet (22.9 m), such as from greater than or equal to 10 feet (3.0 m) to less than or equal to 50 feet (15.2 m). The plate 102 may be substantially planar (i.e., the upper surface 104 and the bottom surface 106 may be substantially parallel). In other embodiments, the plate 102 may be non-planar, such as dished. When the plate 102 is dished the upper surface 104 and the bottom surface 106 may not be planar (e.g., the outer surface 108 of the plate 102 may be higher or lower than more central regions of the plate 102).

The bottom surface 106, the upper surface 104, or both of the plate 102 may be refractory-lined. For example, FIG. 1 shows refractory material in cross hatched area above the plate 102. Additionally or alternatively, other materials with insulating properties (e.g., insulating material) may be disposed between the bottom surface 106 and the upper surface 104 of the plate 102. The refractory lining, the insulating material, or both may help prevent the bottom surface 106 of the plate 102 from heating.

The plate 102 may comprise a plurality of apertures 130. Each of the plurality of apertures 130 may be in fluid communication with the bottom surface 106 of the plate 102 and the upper surface 104 of the plate 102 via first apertures 132 and second apertures 134. The plurality of apertures 130 may be even with the upper surface 104 and/or the bottom surface 106. Alternatively, the plurality of apertures 130 may extend past (i.e., below) the bottom surface 106 and/or past (i.e., above) the upper surface 104. That is, the plurality of apertures 130 may include shrouds extending above the upper surface 104 of the plate 102. The second apertures 134 may have a greater cross-sectional area than the first apertures 132.

The first apertures 132 of the plate 102 may provide a pressure drop from the bottom surface 106 of the plate 102 to the upper surface 104 of the plate 102 to ensure an even distribution of gasses passing through the plate 102. The second apertures 134 may reduce the velocity of the gasses passing through the plate 102. If the gasses passing through the plate 102 are at too high of a velocity, the gasses may attrite or damage catalyst in the chemical processing vessel 110 above the plate 102. The first apertures 132 and the second apertures 134 of the plate 102 may have uniform or varying cross-sectional areas to help provide that an even distribution of gas passes through each of the plurality of apertures 130. For instance, apertures 130 that are nearer to fluid inlet 123 may have a greater pressure difference between the bottom surface 106 and the upper surface 104 of the plate 102. As such, first apertures 132 of the plate 102 that are nearer to the fluid inlet 123 can have a smaller cross-sectional area than first apertures 132 that are further from the fluid inlet 123 to help equilibrate a pressure differential across the plate 102.

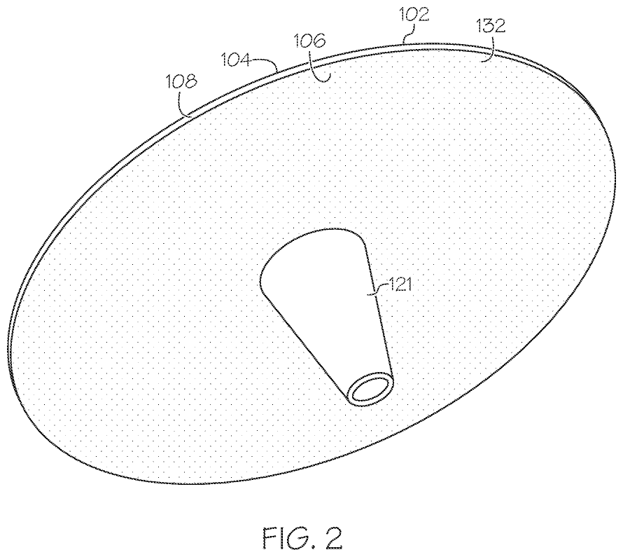

Referring to FIGS. 1 and 2 in combination, the plate 102 may include a bottom surface 106. The bottom surface 106 can include a plurality of apertures 130, formed by first apertures 132 of the plate 102. The plurality of apertures 130 may be arranged around the longitudinal axis A in a geometric pattern. The geometric pattern may be different for various applications. For example, the plurality of apertures 130 may be arranged around the longitudinal axis A in a grid and/or concentrically. The plate 102 can include 10 to 50 apertures 130 per square meter, such as between 20 to 35 apertures per square meter. Other numbers of apertures 130 per square meter are also contemplated.

Referring again to FIG. 1, a ratio of an inside diameter of the first apertures 132 of the plate 102 to an inside diameter of the second apertures 134 of the plate 102 may be from 0.13 to 0.8, such as from 0.34 to 0.51. A ratio of the inside diameter of the first apertures 132 of the plate 102 to the inside diameter of the chemical processing vessel 110 may be from 0.003 to 0.014, such as from 0.008 to 0.012. A ratio of the inside diameter of the second apertures 134 of the plate 102 to the inside diameter of the chemical processing vessel 110 may be from 0.008 to 0.163, such as from 0.026 to 0.087.

Referring still to FIG. 1, the chemical processing vessel 110 may comprise an outer skirt 150. The outer skirt 150 may mount and support the grid distributor 100 to the chemical processing vessel 110 at or near the base 116 of the chemical processing vessel 110. The outer skirt 150 may extend downward at or near an outer periphery of the grid distributor 100. As used in the present disclosure, “an outer periphery” may refer to the outermost (i.e., portion closest to the refractory-lined inner wall) 25% of the plate 102. The outer skirt 150 may extend from the outer periphery of the grid distributor 100 to an outer periphery of the base 116 such that it is disposed radially (e.g. in the radial direction R) around the periphery of the base 116 and grid distributor 100. The outer skirt 150 may be centered about the longitudinal axis A.

The outer skirt 150 may include a first end 152 and a second end 154. The outer skirt 150 is shaped as a frustum in FIG. 1, where the first end 152 and second end 154 are circular, but other shapers are contemplated. The first end 152 may connected to the base 116 of the chemical processing vessel 110. The plate 102 may be connected to the outer skirt 150 at or near the second end 154. In some embodiments, as depicted in FIG. 1, the outer skirt 150 extends upwardly to the height of the refractory material. The first end 152 and the second end 154 may be spaced apart from one another and generally form a wall. The space between the first end 152 and the second end 154 may define the thickness of the outer skirt 150 at a particular region, where the outer skirt 150 comprises an outer surface 156 and an inner surface 158.

In embodiments, the outer surface 156 may be spaced apart from the refractory-lined inner wall 112. Plate grid distributor packing (i.e., insulation) may be disposed between a lower portion of refractory-lined inner wall 112 that is nearer to where the refractory-lined inner wall 112 connects to the base 116 of the chemical processing vessel 110 and the outer surface 108 of the plate 102. The plate grid distributor packing may be ceramic wool insulation. In embodiments, the outer skirt 150 may be angled such that it forms a substantially frustum-shaped wall. Alternatively, the outer skirt 150 may be vertical (i.e., perpendicular to the base 116 or parallel to the side walls 111).

Referring still to FIG. 1, the chemical processing vessel 110 may include the solids transport passage 121. In embodiments, the solids transport passage 121 may comprise a conical frustum. As used in the present disclosure, a “conical frustum” may refer to a frustum shape created by cutting the top off a cone (with the cut being made parallel to the base). The solids transport passage 121 may extend from a top opening 121B at or near the grid distributor 100 to a bottom opening 121A at or below the catalyst outlet 120. The solids transport passage 121 may therefore extend between the base and the grid distributor 100. In embodiments, the solids transport passage 121 may be aligned with the longitudinal axis A such that it extends between the base 116 and the grid distributor 100 at a central region of the base 116 and the grid distributor 100, respectively. The solids transport passage 121 may form a passage from an area above the grid distributor 100 to the catalyst outlet 120.

The solids transport passage 121 and the plate 102 may be connected such that they form a unitary body. As used herein, a unitary body may mean that two components (e.g., the solids transport passage 121 and the plate 102) are formed from a single structure. Without being bound to any particular theory, it is believed that a unitary body may be lighter and more rigid than a construction using separate pieces. The plate 102 and solids transport passage 121 may be operable to contain catalyst below the plate 102 inside the solids transport passage 121. It should be understood that catalyst may also be above the plate 102 as well as within the solids transport passage 121. The solids transport passage 121 may comprise a rounded transition 126 between the solids transport passage 121 and the plate 102. A “rounded transition” may refer to a rounding of an interior or exterior corner of a part design. Rounded geometry, when on an interior corner is a line of concave function, whereas a rounded geometry on an exterior corner is a line of convex function. The rounded transition 126 may provide a smooth transition from the plate 102 to the solids transport passage 121. A refractory material may be in direct contact with and may cover substantially all of an inner surface of the solids transport passage 121.

The solids transport passage 121 may not extend above the plate 102. The rounded transition 126 of the solids transport passage 121 may provide a flush transition from the solids transport passage 121 to the plate 102. That is, an upper surface 128 of the solids transport passage 121 may be substantially planar with the upper surface 104 of the plate 102. Such a design may minimize the catalyst inventory needed in chemical processes being performed in the chemical processing vessel 110. Conventional plate grid distributors and catalyst withdrawal standpipes may require a hopper cone above the conventional plate grid distributor. Any particulate solids above the plate of the conventional plate grid distributor and in the hopper cone are, in some embodiments, not useful and may increase catalyst inventory cost unnecessarily.

The solids transport passage 121 may have a greater cross-sectional area at the central opening 121B of the plate 102 than at the catalyst outlet 120. In embodiments, solids transport passage 121 may be from 2 to 6 times larger than the catalyst outlet 120, such as from 3.5 to 4.5 times larger. Accordingly, the cross sectional-area of the solids transport passage 121 may be from 2 to 6 times larger at the central opening 121B of the plate 102 than at the catalyst outlet 120, such as from 3.5 to 4.5 times larger.

During operation, particulate solids, such as catalyst particulates, may be removed from the chemical processing vessel 110 via the solids transport passage 121. The solids transport passage 121 may be connected to a standpipe (not shown) to deliver the particulate solids to another vessel or processing unit. During operation, catalyst may be withdrawn from the chemical processing vessel 110, and passed to the standpipe, at a catalyst flux of greater than or equal to 50 lb/ft²-sec to less than or equal to 400 lb/ft²-sec, such as from greater than or equal to 100 lb/ft²-sec to less than or equal to 300 lb/ft²-sec. The fluid inlet 123 may deliver a gas into the chemical processing vessel 110 through the grid distributor 100 while the particulate solids may be removed via the solids transport passage 121. As such, the solids transport passage 121 forms a barrier between catalyst and gases that are eventually distributed. As will now be appreciated, the solids transport passage 121, the base 116, the outer skirt 150, and the grid distributor 100 may define an annular region 180 between the outer skirt 150 and the solids transport passage 121.

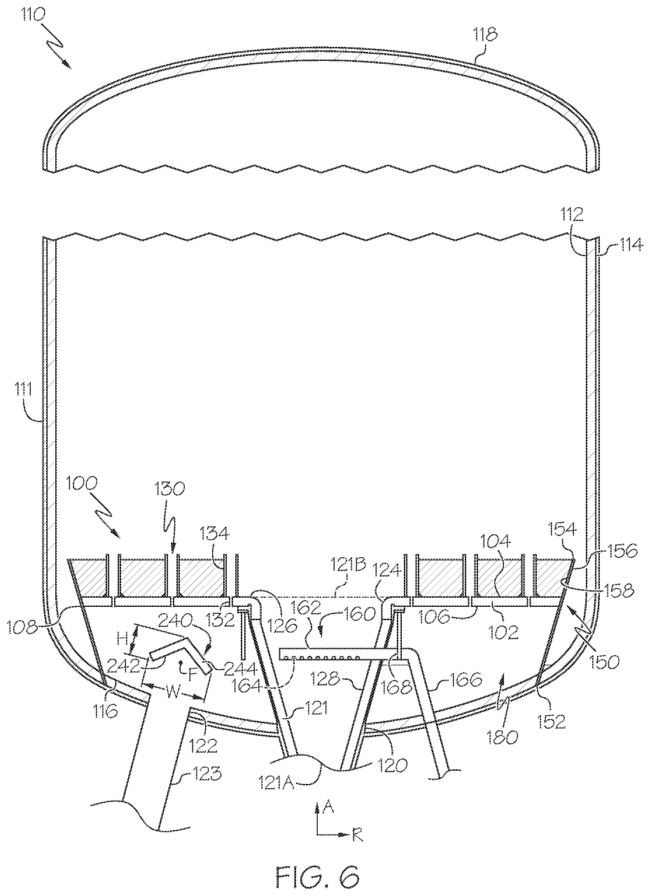

Referring still to FIG. 1, the chemical processing vessel 110 may include a fluid inlet 123. The fluid inlet 123 may be connected to a receiving passageway 122 that extends through the base of the chemical processing vessel 110. The fluid inlet 123 may define a fluid opening 124 through which a fluid, such as air, may enter the annular region 180. The chemical processing vessel 110 may include a plurality of fluid inlets 123 (not shown in FIG. 1). In embodiments, the plurality of fluid inlets 123 may be connected to a plurality of receiving passageways 122. The plurality of receiving passageways 122 may encircle the longitudinal axis A of the chemical processing vessel 110. The fluid inlet 123 may be mounted flush with the refractory-lined inner wall 112, such as depicted in FIG. 6, or can extend beyond the refractory-lined inner wall 112, such as depicted in FIG. 1. The fluid inlet 123 may have an inner diameter D, such as depicted in FIG. 1. A ratio of an inner diameter D of the fluid inlet 123 to an inside diameter of the chemical processing vessel 110 may be from 0.02 to 0.4, such as from 0.20 to 0.23.

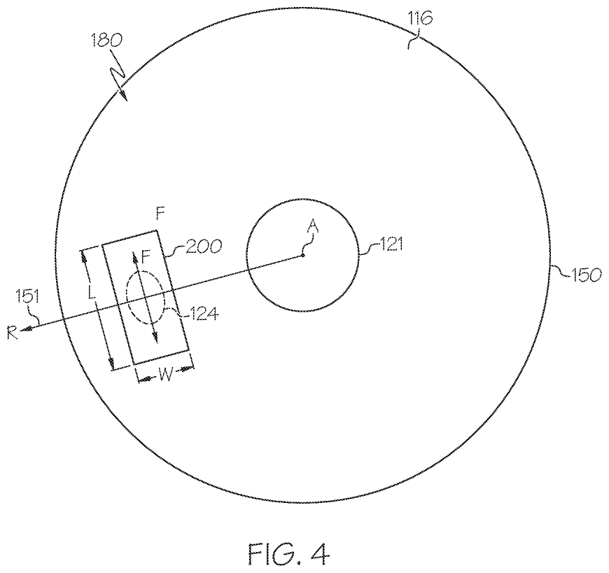

Referring to FIGS. 1 and 4 in combination, the chemical processing vessel 110 may include a fluid director 200 disposed within the annular region 180. The annular region 180 is the generally ring-shaped region bound by the solids transport passage 121 on its inner edge and by the outer skirt 150 on its outer edge, according to its radial direction. The annular region 180 may be bound by the grid distributor 100 on its upper side and by the base 116 on its lower side. As is shown in the “top view” of FIG. 4, the flow direction is into the annular region and around the “ring” shaped area substantially tangential to such.

In one or more embodiments, such as is shown in FIG. 1, the fluid director 200 may be curved, such as depicted. As used herein, “curved” is not limited to rounded shapes but means any rounded or angular shape such that the fluid director 200 does not define a single flat surface. The fluid director 200 may be any curved shape such as angled, arcuate, elliptical, rectangular, cylindrical, irregular shape, combinations thereof, and/or portions thereof. For example, as depicted in FIGS. 1 and 4, the fluid director 200 may have a semi-cylindrical shape extending in a direction perpendicular to the radial direction R and substantially tangential to the outer skirt 150 (e.g. in the flow direction F depicted in FIG. 4). The fluid director 200 may have a height H measured in a direction aligned with the fluid inlet 123, a width W measured in a direction perpendicular to the fluid inlet 123, and a length L measured in a direction perpendicular to the radial direction R (e.g. in the flow direction F depicted in FIG. 4). In embodiments, the length L may be greater than the width W. The height H may be equal to or greater than half of the width W. The width W may be greater than two times the inner diameter D of the fluid inlet 123.

Still referring to FIGS. 1 and 4, the fluid director 200 may be positioned above the fluid inlet 123. The fluid director 200 may be concave in a direction facing the fluid inlet 123 and may be convex in a direction facing away from the fluid inlet 123, such as depicted. In embodiments, the fluid director 200 may be centered above the fluid opening 124. Accordingly, in embodiments, a fluid may enter the chemical processing vessel 110 via the fluid inlet 123 and may impinge upon the fluid director 200. Upon impinging on the fluid director 200, the fluid may be directed along the length L of the fluid director 200 in the flow direction F. In embodiments, the concave shape of the fluid director 200 may assist in directing the fluid in the flow direction F. As described hereinabove, the flow direction F may be substantially tangential to the outer skirt 150. As used herein, “substantially tangential to the outer skirt 150,” means substantially tangential to the outer skirt 150 at a circumferential location 151 that is angularly aligned with the fluid opening 124. For example, referring to FIG. 4, the radial direction R is schematically depicted as an axis that passes through the center of the fluid opening 124 and through the circumferential location 151 of the outer skirt 150. Accordingly, the center of the fluid opening 124 and the circumferential location 151 are angularly aligned. As depicted in FIG. 4, the flow direction F is directed tangentially to the outer skirt 150 at the circumferential location 151.

In embodiments, the flow direction F need not be precisely tangential to the outer skirt 150. Instead, the flow direction F may be substantially tangential to the outer skirt 150. As used herein, “substantially tangential” means that the flow direction F is within +/−15° of the tangential direction of the outer skirt 150 when taken at an angular position aligned with the fluid opening 124. Accordingly, the fluid may be directed into and about the annular region 180. As will be described in greater detail herein, by directing the fluid substantially tangentially to the outer skirt 150 and into the annular region 180, the fluid may be more evenly distributed about the annular region 180. In some embodiments, the fluid may have a lower temperature as compared to the rest of the chemical processing vessel 110. Accordingly, by more evenly distributing the fluid about the annular region 180, there may be a more even thermal distribution about the annular region 180 and about the chemical processing vessel 110.

Referring still to FIGS. 1 and 4, the fluid director 200 may be positioned above the fluid inlet 123 such that it overhangs the fluid inlet 123. In embodiments, the fluid director 200 may overhang the fluid inlet by an overhang distance C, which may be a portion of the height H. The overhang C may be greater than or equal to one half of the inner diameter D of the fluid inlet 123. In some embodiments, the overhang distance C may be greater than 0.15 times the inner diameter D. The overhang distance C may prevent the fluid from moving in the radial direction R and, therefore, may assist in directing the fluid in the flow direction F. As depicted, the overhang distance C may block a direct line of sight between the fluid opening 124 and the solids transport passage 121. Similarly, the overhang distance C may block a direct line of sight between the fluid opening 124 and the outer skirt 150.

In this way, the fluid director 200 may prevent the fluid from directly impinging on the solids transport passage 121 and/or the outer skirt 150 and may instead direct the fluid into and about the annular region 180. This may be beneficial in some embodiments as direct impingement of the fluid may create thermal gradients within the solids transport passage 121 and/or the outer skirt 150. For example, in embodiments in which the temperature of the fluid is lower than an operating temperature of the chemical processing vessel 100, direct impingement of the fluid on the solids transport passage 121 may create a “cold” spot, wherein the temperature of the solids transport passage 121 at the location of impingement is lower than the surrounding temperatures of the solids transport passage 121. By preventing such direct impingement, the solids transport passage 121 may have more even temperatures and, accordingly, lower thermal stresses.

Referring still to FIGS. 1 and 4, the fluid director 200 may be positioned above the fluid inlet 123 such that it is spaced apart from the base 116. In particular, in some embodiments, the fluid director 200 may have a minimum distance between the fluid director 200 and the base 116 that is greater than 0.5 times the inner diameter D of the fluid inlet 123. In some embodiments, the fluid director 200 may have a minimum distance between the fluid director 200 and the base 116 that is greater than the inner diameter D of the fluid inlet 123.

In embodiments, the fluid director 200 may be positioned above the fluid inlet 123 such that it is spaced apart from the bottom surface 106 of the plate 102. In some embodiments, the fluid director 200 may be coupled to the bottom surface 106 via one or more supports (not pictured) extending between the bottom surface 106 and the fluid director 200 such that the fluid director 200 is fixed in place. In some embodiments, the fluid director 200 may be coupled to the fluid inlet 123 via one or more supports (not pictured) extending between the fluid inlet 123 and the fluid director 200 such that the fluid director 200 is fixed in place. In some embodiments, the fluid director 200 may be coupled to the base 116 via one or more supports (not pictured) extending between the base 116 and the fluid director 200 such that the fluid director 200 is fixed in place.

The fluid director 200 may deflect and/or reduce a velocity of the fluid entering the chemical processing vessel 110 via the fluid inlet 123. The deflection and/or redirection in velocity may cause the fluid to be more evenly distributed about the annular region 180 and through the plurality of apertures 130. As a result, the temperatures of the chemical processing vessel 110 may be more uniform.

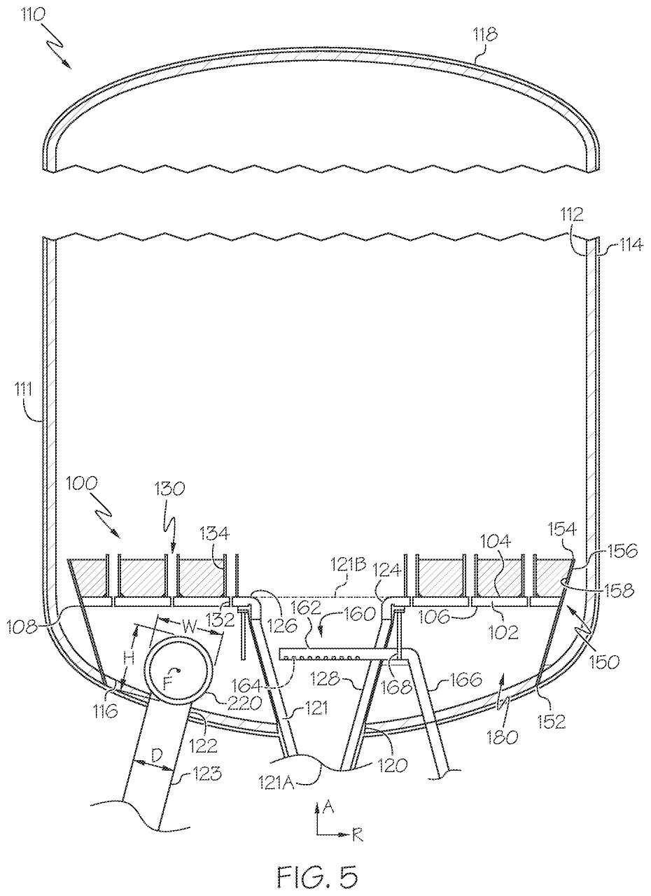

Referring now to FIG. 5, another embodiment of a fluid director 220 is schematically depicted. The fluid director 220 is substantially similar to the fluid director 200. Accordingly, like numbers and letters will be used in reference to like features. For example, the fluid director 220 may have a height H measured in a direction aligned with the fluid inlet 123 and a width W measured in a direction perpendicular to the fluid inlet 123. The fluid director 220 may also have a length L (not depicted in FIG. 5) measured in a direction perpendicular to the radial direction R (e.g. in the flow direction F). As shown, the fluid director 220 may have a hollow cylinder shape extending in the flow direction F. Referring briefly to FIG. 4, the fluid director 220 may look the same as the fluid director 200 when viewed from above, such as depicted. Referring back to FIG. 5, the fluid director 220 may be coupled to the fluid inlet 123 to form a “T” with the fluid inlet 123. Accordingly, a fluid may enter the fluid director 220 via the fluid inlet 123 and may be directed by the fluid director 220 into the annular region 180 in the flow direction F.

Referring now to FIG. 6, another embodiment of a fluid director 240 is schematically depicted. The fluid director 240 is substantially similar to the fluid directors 200 and 220. Accordingly, like numbers and letters will be used in reference to like features. For example, the fluid director 240 may have a height H measured in a direction aligned with the fluid inlet 123 and a width W measured in a direction perpendicular to the fluid inlet 123. The fluid director 240 may also have a length L (not depicted in FIG. 5) measured in a direction perpendicular to the radial direction R (e.g. in the flow direction F). As shown, the fluid director 240 may have a first plate 242 and a second plate 244, each extending in the flow direction F. The first plate 242 may be oriented at an angle to a second plate 244. The first plate 242 and the second plate 244 may jointly define a concave surface in a direction facing the fluid inlet 123. In this way, the first plate 242 and the second plate 244 may substantially prevent the fluid from moving in the radial direction R and, therefore, may direct the fluid in the flow direction F. Accordingly, the fluid inlet 123 and may be directed by the fluid director 240 into the annular region 180 in the flow direction F.

Referring back to FIG. 1, in embodiments, the chemical processing vessel 110 may include a sparger 160 above the plate 102 or within the solids transport passage 121 operable to direct a gas toward the catalyst outlet 120. The sparger may be utilized to fluidize materials passing through the solids transport passage 121, which, in some embodiments, may defluidize without use of a sparger due to the relatively large size of the solids transport passage 121. The sparger 160 may include a sparger body 162 and a plurality of sparger apertures 164. During operation, a fluid may be directed into the sparger body 162 and through the plurality of sparger apertures 164 to help fluidize particulate solids from the chemical processing vessel 110. The fluid may be directed downward toward the catalyst outlet 120 and may help fluidize the particulate solids from above the plate 102, through the solids transport passage 121, and out of the catalyst outlet 120. The fluid may be directed into the sparger body through a sparger feed pipe 166. The sparger 160 may deliver an oxygen-containing gas or an inert gas, such as nitrogen, into the chemical processing vessel 110.

In embodiments, the chemical processing vessel 110 may include multiple spargers 160, such as two, three, five, or any number of spargers 160. In embodiments, the grid distributor 100 may comprise one or more loops 168. The one or more loops 168 may be fixed to the plate 102 using any conventional or yet-to-be developed means, such as welding. The one or more loops 168 may provide mechanical support to the sparger 160. The sparger 160 may comprise a refractory material lining the exterior of the sparger body 162 of the sparger 160. As used herein, a refractory material is a material that may be resistant to decomposition by heat, pressure, or chemical attack, and may retain strength and form at high temperatures. Oxides of aluminum, silicon, magnesium, and calcium may be common materials used in the manufacturing of refractory materials.

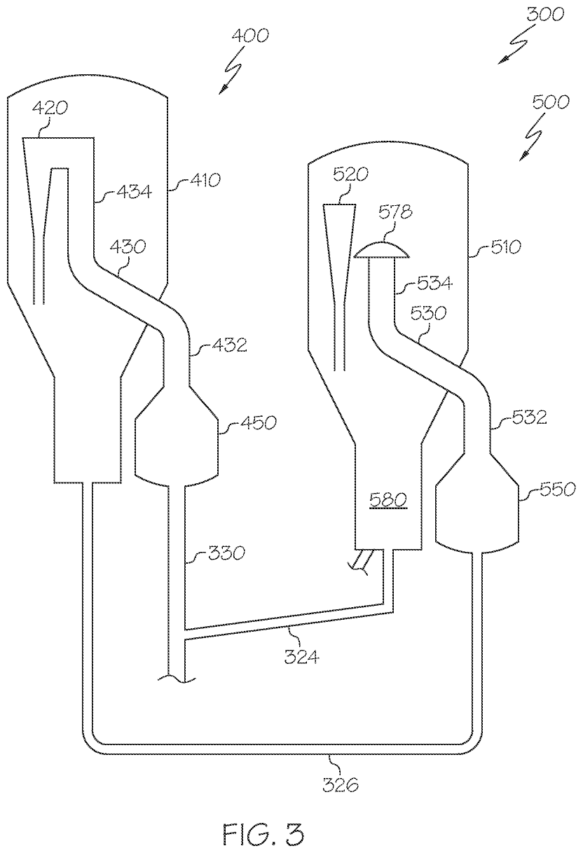

Now referring to FIG. 3, an example reactor system 300 in which the chemical processing vessels 110 of the present disclosure may be present is schematically depicted. The reactor system 200 generally comprises multiple system units, such as a reactor section 400 and a regenerator section 500. As used herein in the context of FIG. 3, a reactor section 400 generally refers to the portion of a reactor system 300 in which the major process reaction takes place, and the particulate solids are separated from the product stream of the reaction. In one or more embodiments, the particulate solids may be spent, meaning that they are at least partially deactivated. Also, as used herein, a regenerator section 500 generally refers to the portion of a reactor system 300 where the particulate solids are regenerated, such as through combustion, and the regenerated particulate solids are separated from the other process material, such as evolved gasses from the combusted material previously on the spent particulate solids or from supplemental fuel. The reactor section 400 generally includes a reaction vessel 450, a riser 430 including an exterior riser segment 432 and an interior riser segment 434, and a particulate solid separation section 410. The regenerator section 500 generally includes a particulate solid treatment vessel 550, a riser 530 including an exterior riser segment 532 and an interior riser segment 534, and a particulate solid separation section 510. Generally, the particulate solid separation section 410 may be in fluid communication with the particulate solid treatment vessel 550, for example, by standpipe 526, and the particulate solid separation section 510 may be in fluid communication with the reaction vessel 450, for example, by standpipe 324 and transport riser 330.

Generally, the reactor system 300 may be operated by feeding a hydrocarbon feed and fluidized particulate solids into the reaction vessel 450, and reacting the hydrocarbon feed by contact with fluidized particulate solids to produce a product in the reaction vessel 450 of the reactor section 400. The product and the particulate solids may be passed out of the reaction vessel 450 and through the riser 430 to a gas/solids separation device 420 in the particulate solid separation section 410, where the particulate solids may be separated from the product. The particulate solids may then be transported out of the particulate solid separation section 410 to the particulate solid treatment vessel 550. In the particulate solid treatment vessel 550, the particulate solids may be regenerated by chemical processes. For example, the spent particulate solids may be regenerated by one or more of oxidizing the particulate solid by contact with an oxygen containing gas, combusting coke present on the particulate solids, and combusting a supplemental fuel to heat the particulate solid. The particulate solids may then be passed out of the particulate solid treatment vessel 550 and through the riser 530 to a riser termination device 578, where the gas and particulate solids from the riser 530 are partially separated. The gas and remaining particulate solids from the riser 530 are transported to gas/solids separation device 520 in the particulate solid separation section 510 where the remaining particulate solids are separated from the gasses from the regeneration reaction. The particulate solids, separated from the gasses, may be passed to a solid particulate collection area 580, which may be structured as the grid distributor 100 of the chemical processing vessels of the present disclosure (as further detailed in FIGS. 1-2). The separated particulate solids are then passed from the solid particulate collection area 580 to the reaction vessel 450, where they are further utilized. Thus, the particulate solids may cycle between the reactor section 400 and the regenerator section 500.

The solid particulate collection area 580 may also include an oxygen treatment zone. The oxygen treatment zone may be in fluid communication with reaction vessel 450 (e.g., via standpipe 324 and transport riser 330), which may supply processed catalyst from the catalyst processing portion 500 back to a reactor portion 400 of the reactor system 300. The oxygen treatment zone may include an oxygen-containing gas inlet 328, such as the fluid inlet 123 of the grid distributor 100 of the present disclosure, which may supply an oxygen-containing gas to the oxygen treatment zone for oxygen treatment of the catalyst.

Referring again to FIG. 1, the present disclosure is also directed toward methods of operating a chemical processing vessel 110. The method may include passing a fluid into the chemical processing vessel 110 at reaction conditions through a fluid inlet 123 below the grid distributor 100 and directing the fluid through a grid distributor 100 in the chemical processing vessel 110. The grid distributor 100 may include a plate 102 comprising an upper surface 104 and a lower surface 106 opposite the upper surface defining a thickness of the plate 102. The plate 102 may include a plurality of apertures 130 extending through the thickness of the plate 102. The plate 102 may include a central opening 121B. A solids transport passage 121 may extend from the central opening 121B to the catalyst outlet 120 forming a passage from an area above the plate 102 to the catalyst outlet 120. The solids transport passage 121 and the plate 102 may be connected such that they form a unitary body. The solids transport passage 121 may have a greater cross section area at the central opening 121B of the plate 102 than at the catalyst outlet 120. The method may include passing catalyst from above the plate 102, through the solids transport passage 121, and out of the chemical processing vessel 110 through the catalyst outlet 120.

The chemical processing vessel 110 may have any of the features previously discussed in this disclosure for the chemical processing vessel 110. The grid distributor 100 may have any of the features previously discussed in this disclosure for the grid distributor 100. The solids transport passage 121 may have any of the features previously discussed in this disclosure for the solids transport passage 121.

### EXAMPLES

Examples are provided herein which may disclose one or more embodiments of the present disclosure. However, the Examples should not be viewed as limiting on the claimed embodiments hereinafter provided.

### Example 1: Effect of Fluid Director Geometry on Temperatures Within a Chemical Processing Vessel

In Example 1, a 3D computational fluid dynamics (CFD) model was used to compare a chemical processing vessel with a fluid director having a flat geometry (hereinafter “Fluid Director A”) to a chemical processing vessel with a fluid director having an arcuate shape (hereinafter “Fluid Director B”). The model utilized the software Ansys Fluent Version 19.4. Both chemical processing vessels have fluid inlet providing a gas stream with a temperature of 30 °C and an inlet velocity of 40 ft/sec. Both chemical processing vessels direct the gas stream into a fluidized bed reactor operating at a temperature of °C that has a center withdrawal standpipe with 5 inch thermal insulation refractory lining.

In Example 1, Fluid Director A has a circular, flat plate geometry with a diameter of 24 in. that is oriented parallel to the grid distributor and positioned approximately 12 in. away from the fluid inlet (center-to-center spacing). Conversely, Fluid Director B has a curved geometry, such as described with reference to the fluid director 200, hereinabove. Specifically, the Fluid Director B has a semi-cylindrical geometry with a height of 18 in., a width of 36 in., and a length of 36 in. The Fluid Director B is oriented above the fluid inlet such that it is 14.5 in. away from the fluid inlet at the furthest point and overhangs the fluid inlet by 3.5 in.

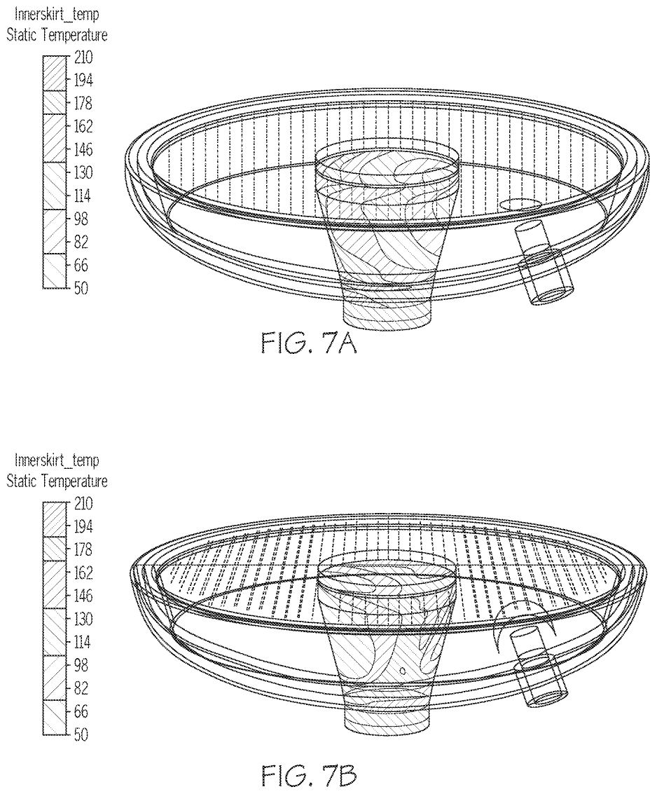

As shown in FIGS. 7A and 7B, the temperatures of a solids transport passage of a chemical processing vessel having the Fluid Director A (FIG. 7A) are compared to the temperatures of a solids transport passage of a chemical processing vessel having the Fluid Director B (FIG. 7B). The temperatures of the solids transport passages were obtained from the CFD model. As shown in FIGS. 7A and 7B, compared to the Fluid Director A, the Fluid Director B demonstrates more uniform temperatures about the solids transport passage. Specifically, as shown in FIG. 7A, the maximum temperature difference about the solids transport passage may be about 160 °C when the chemical processing vessel has the Fluid Director A. Conversely, as shown in FIG. 7B, the maximum temperature difference about the solids transport passage may be less than or equal to about 80 °C when the chemical processing vessel has the Fluid Director B. Accordingly, in embodiments, a curved fluid director, such as the Fluid Director B may limit a maximum difference of the solids transport passage to less than about 160 °C, less than about 100 °C, or less than about 80 °C.

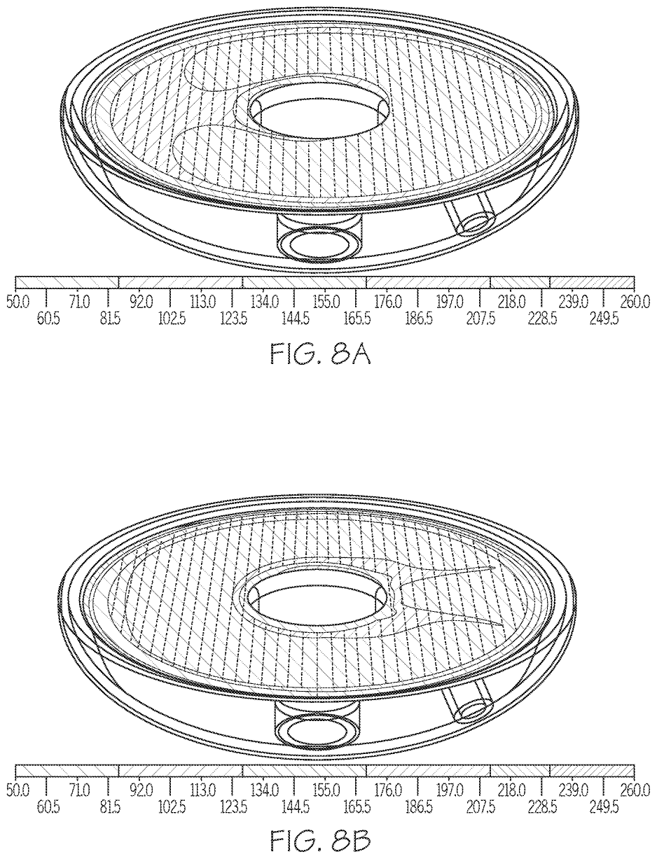

As shown in FIGS. 8A and 8B, the temperatures of a grid distributor of a chemical processing vessel having the Fluid Director A (FIG. 8A) are compared to the temperatures of a grid distributor of a chemical processing vessel having the Fluid Director B (FIG. 8B). The temperatures of the grid distributors were obtained from the CFD model. As shown in FIGS. 8A and 8B, as compared to the flow Director A, the flow Director B demonstrates more uniform temperatures of the grid distributor. Specifically, as shown in FIG. 8A, the maximum temperature difference about the grid distributor may be about 60 °C when the chemical processing vessel has the Fluid Director A. As shown in FIG. 8B, the maximum temperature difference about the grid distributor may be about 40 °C when the chemical processing vessel has the Fluid Director B. Accordingly, in embodiments, a curved fluid director, such as the Fluid Director B may limit a maximum difference of the grid distributor to less than about 60 °C, less than about 50 °C, or less than about 40 °C.

One or more aspects of the present disclosure are described herein. One aspect may include a chemical processing vessel comprising: a base; a grid distributor; a solids transport passage extending between the base and the grid distributor at a central region of the base and the grid distributor, respectively; an outer skirt comprising a wall disposed radially around a periphery of the base and the grid distributor, wherein the base, the grid distributor, the solids transport passage, and the outer skirt define an annular region between the outer skirt and the solids transport passage; a fluid inlet extending through the base and into the annular region; and a fluid director disposed within the annular region and shaped to direct a fluid from the fluid inlet into the annular region in a fluid direction that is substantially tangential to the outer skirt.

Another aspect is any single above aspect or combination of above aspects, wherein the fluid inlet is a pipe, and wherein the fluid director overhangs the fluid inlet.

Another aspect is any single above aspect or combination of above aspects, wherein the fluid director has a semi-cylindrical shape.

Another aspect is any single above aspect or combination of above aspects, wherein the fluid director has a cylindrical shape.

Another aspect is any single above aspect or combination of above aspects, wherein the fluid director has a height in a first direction aligned with the fluid inlet and a width in a second direction perpendicular to the fluid inlet, wherein the height is equal to or greater than half of the width.

Another aspect is any single above aspect or combination of above aspects, wherein the fluid director has a height in a first direction aligned with the fluid inlet, a width in a second direction perpendicular to the fluid inlet, and a length in a third direction aligned with the flow direction, wherein the length is equal to or greater than the width.

Another aspect is any single above aspect or combination of above aspects, wherein: the fluid inlet has a diameter; the fluid director has a height in a first direction aligned with the fluid inlet and a width in a second direction perpendicular to the fluid inlet; and the width is equal to or greater than two times the diameter of the fluid inlet.

Another aspect is any single above aspect or combination of above aspects, wherein the fluid director is spaced apart from the base.

Another aspect is any single above aspect or combination of above aspects, wherein the fluid director is spaced apart from the grid distributor.

Another aspect is any single above aspect or combination of above aspects, wherein the fluid director is coupled to the fluid inlet.

Another aspect is any single above aspect or combination of above aspects, wherein the fluid director is coupled to the base.

Another aspect is any single above aspect or combination of above aspects, wherein one or both of: the fluid director is centered relative to the fluid inlet; or the fluid director blocks a direct line of sight between the fluid inlet and the solids transport passage.

Another aspect is any single above aspect or combination of above aspects, wherein the wall of the outer skirt is substantially frustum-shaped.

Another aspect may include a method of operating a chemical processing vessel, the method comprising: passing a fluid into the chemical processing vessel, the chemical processing vessel comprising: a base; a grid distributor; a solids transport passage extending between the base and the grid distributor at a central region of the base and the grid distributor, respectively; an outer skirt comprising a substantially frustum-shaped wall disposed radially around a periphery of the base and the grid distributor, wherein the base, the grid distributor, the solids transport passage, and the outer skirt define an annular region between the outer skirt and the solids transport passage; a fluid inlet extending through the base and into the annular region; and a fluid director disposed within the annular region and shaped to direct a fluid from the fluid inlet into the annular region in a fluid direction that is substantially tangential to the outer skirt; and directing the fluid with the fluid director, wherein the fluid is directed from the fluid inlet into the annular region in a fluid direction that is substantially tangential to the outer skirt.

Another aspect is any single above aspect or combination of above aspects, wherein directing the fluid with the fluid director limits a maximum temperature difference of the solids transport passage to less than 100 °C.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A chemical processing vessel comprising:
a base;
a grid distributor;
a solids transport passage extending between the base and the grid distributor at a central region of the base and the grid distributor, respectively;
an outer skirt comprising a wall disposed radially around a periphery of the base and the grid distributor, wherein the base, the grid distributor, the solids transport passage, and the outer skirt define an annular region between the outer skirt and the solids transport passage;
a fluid inlet extending through the base and into the annular region; and
a fluid director disposed within the annular region and shaped to direct a fluid from the fluid inlet into the annular region in a fluid direction that is substantially tangential to the outer skirt.

2. The chemical processing vessel of claim 1, wherein the fluid inlet is a pipe, and wherein the fluid director overhangs the fluid inlet.

3. The chemical processing vessel of claim 1, wherein the fluid director has a semi-cylindrical shape.

4. The chemical processing vessel of claim 1, wherein the fluid director has a cylindrical shape.

5. The chemical processing vessel of claim 1, wherein the fluid director has a height in a first direction aligned with the fluid inlet and a width in a second direction perpendicular to the fluid inlet, wherein the height is equal to or greater than half of the width.

6. The chemical processing vessel of claim 1, wherein the fluid director has a height in a first direction aligned with the fluid inlet, a width in a second direction perpendicular to the fluid inlet, and a length in a third direction aligned with the flow direction, wherein the length is greater than the width.

7. The chemical processing vessel of claim 1, wherein:
the fluid inlet has a diameter;
the fluid director has a height in a first direction aligned with the fluid inlet and a width in a second direction perpendicular to the fluid inlet; and
the width is equal to or greater than two times the diameter of the fluid inlet.

8. The chemical processing vessel of claim 1, wherein the fluid director is spaced apart from the base.

9. The chemical processing vessel of claim 1, wherein the fluid director is spaced apart from the grid distributor.

10. The chemical processing vessel of claim 1, wherein the fluid director is coupled to the fluid inlet.

11. The chemical processing vessel of claim 1, wherein the fluid director is coupled to the base.

12. The chemical processing vessel of claim 1, wherein one or both of:
the fluid director is centered relative to the fluid inlet; or
the fluid director blocks a direct line of sight between the fluid inlet and the solids transport passage.

13. The chemical processing vessel of claim 1, wherein the wall of the outer skirt is substantially frustum-shaped.

14. A method of operating a chemical processing vessel, the method comprising:
passing a fluid into the chemical processing vessel, the chemical processing vessel comprising:
a base;
a grid distributor;
a solids transport passage extending between the base and the grid distributor at a central region of the base and the grid distributor, respectively;
an outer skirt comprising a substantially frustum-shaped wall disposed radially around a periphery of the base and the grid distributor, wherein the base, the grid distributor, the solids transport passage, and the outer skirt define an annular region between the outer skirt and the solids transport passage;
a fluid inlet extending through the base and into the annular region; and
a fluid director disposed within the annular region and shaped to direct a fluid from the fluid inlet into the annular region in a fluid direction that is substantially tangential to the outer skirt; and
directing the fluid with the fluid director, wherein the fluid is directed from the fluid inlet into the annular region in a fluid direction that is substantially tangential to the outer skirt.

15. The method of claim 14, wherein directing the fluid with the fluid director limits a maximum temperature difference of the solids transport passage to less than 100 °C.
